(19) United States
(12) Patent Application Publication
(10) Pub. No.: US 2017/0364674 A1
(43) Pub. Date: Dec. 21, 2017

(54) METHODS AND SYSTEMS FOR ACCESSING A SECURE SYSTEM

(71) Applicant: General Electric Company, Schenectady, NY (US)

(72) Inventors: Robert William GRUBBS, Salem, VA (US); Justin Varkey JOHN, Schenectady, NY (US)

(21) Appl. No.: 15/528,266

(22) PCT Filed: Nov. 20, 2014
(86) PCT No.: PCT/US2014/066566

§ 371 Date: May 19, 2017

(51) Int. Cl. G06F 21/36; G06F 21/32; G06K 19/10; G06K 7/14

(52) U.S. Cl. CPC G06F 21/36; G06K 19/10; G06F 21/32; G06K 7/1413; G06K 7/1417

(57) ABSTRACT

Systems and methods are described for accessing a secure system requiring multi-point authentication by receiving an optical image, wherein the optical image includes at least a portion of an identification badge; determining a plurality of characteristics from the optical image of at least a portion of the identification badge; comparing one or more of the plurality of characteristics to a database of characteristics of authorized users; assigning a confidence factor based on the comparison; and prompting for a second form of authentication if the confidence factor meets or exceeds a threshold or denying access to the secure system if the confidence factor does not meet or exceed the threshold.

### BACKGROUND

In most companies employees are provided with a badge used to gain access into secure buildings and different areas owned by the company. These badges are usually unique and difficult to duplicate. When logging into a computer system owned by the company or any secure system, a form of multi-point authentication is generally used that requires a password and a separate username. Often; however, the username is easily known by other individuals in the company or can be easily deciphered by others, which may decrease the level of security. Furthermore, by the use of a password and username, both of which must be remembered by a user attempting to access a secure system, ease of access is decreased. There is also the possibility may write down or keep passwords and usernames in an unsecure location.

Therefore, what are needed are systems and methods that overcome challenges in the art, some of which are described above.

### SUMMARY

Embodiments of the invention described herein allow a user to use a physical ID badge to log into the computer system. The badge can serve where a traditional username would typically be used and a password would be used for authentication. The used of the ID badge adds an extra layer of protection where it is harder to duplicate a physical badge and reduces the amount of methods the company needs to maintain for access into their systems.

In one aspect, a method of accessing a secure system requiring multi-point authentication is described. One embodiment of the method comprises receiving an optical image, wherein the optical image includes at least a portion of an identification badge; determining a plurality of characteristics from the optical image of at least a portion of the identification badge; comparing one or more of the plurality of characteristics to a database of characteristics of authorized users; assigning a confidence factor based on the comparison; and prompting for a second form of authentication if the confidence factor meets or exceeds a threshold or denying access to the secure system if the confidence factor does not meet or exceed the threshold.

Alternatively or optionally, the secure system can comprise a secure computer system such as, for example, a secure control system.

Alternatively or optionally, receiving the optical image can comprise receiving a digital image or video from a digital camera or a display screen with sensors.

Alternatively or optionally, determining a plurality of characteristics from the optical image of at least a portion of the identification badge can comprise using a processor executing recognition algorithms encoded as computer-readable instructions to determine the characteristics, the one or more recognition algorithms executed by the processor can include one or more of principal component analysis algorithms, Fisherface recognition algorithms, eigenfaces recognition algorithms, linear discriminate analysis algorithms, or combinations and modifications thereof, and the like.

Another aspect of embodiments of the present invention comprises a system for accessing a secure system requiring multi-point authentication. One embodiment of the system comprises an image capture mechanism, wherein the image capture mechanism captures an optical image that includes at least a portion of an identification badge; a memory; and a processor in communication with the memory, wherein the processor determines by executing one or more recognition algorithms encoded as computer-executable instructions stored in the memory, a plurality of characteristics from the optical image of at least a portion of the identification badge; compares one or more of the plurality of characteristics to characteristics of authorized users, the database stored on the memory; assigns a confidence factor based on the comparison; and prompts for a second form of authentication if the confidence factor meets or exceeds a threshold or denies access to the secure system if the confidence factor does not meet or exceed the threshold.

Yet another aspect of embodiments of the present invention comprises a non-transitory computer-readable medium having computer-readable instructions for accessing a secure system requiring multi-point authentication stored thereon, which when executed by a processor, cause the processor to: receive an optical image, wherein the optical image includes at least a portion of an identification badge; determine a plurality of characteristics from the optical image of at least a portion of the identification badge; compare one or more of the plurality of characteristics to a database of characteristics of authorized users; assign a confidence factor based on the comparison; and prompt for a second form of authentication if the confidence factor meets or exceeds a threshold or denying access to the secure system if the confidence factor does not meet or exceed the threshold.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an exemplary overview system for accessing a secure system.

FIG. 2 is a flow diagram illustrating example operations for performing the steps of accessing a secure system requiring multi-point authentication.

FIG. 3 is a block diagram of an example computing device upon which embodiments of the invention may be implemented.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

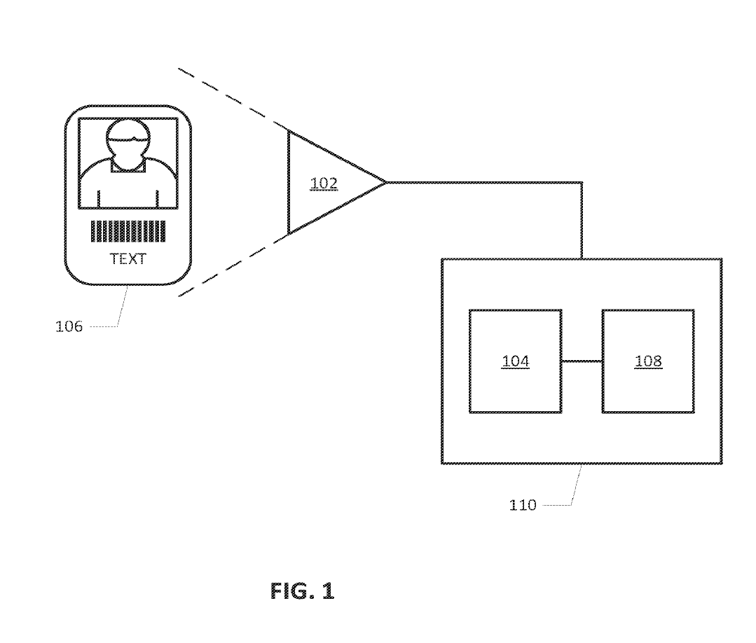

FIG. 1 illustrates an exemplary overview system for accessing a secure system 110. In one aspect, the secure system 110 requires multi-point authentication prior to providing access to a user. As shown in FIG. 1, one embodiment of the system comprises an image capture mechanism 102. In one aspect, the image capture mechanism 102 can be camera, such as a webcam. Generally, it will be a digital camera, but can be an analog device equipped with or in communication with an appropriate analog/digital converter. The image capture mechanism 102 may also be a scanner, recorder, or any other device capable of capturing a still image or a video. In one aspect, the image capture mechanism 102 can be a display or scanner equipped with sensor technology. For example, the image capture mechanism 102 can be a display equipped with Microsoft PixelSense™ technology (Microsoft Corporation, Redmond, Wash. USA), or any similar technology. The display can be a touchscreen display. In one aspect, the image capture mechanism 102 can be an optical scanner that is integrated into a touchscreen display. In one aspect, the image capture mechanism 102 is in direct communication with a processor 104 through, for example, a network (wired (including fiber optic), wireless or a combination of wired and wireless) or a direct-connect cable (e.g., using a universal serial bus (USB) connection, IEEE 1394 “Firewire” connections, and the like). In other aspects, the image capture mechanism 102 can be located remotely from the processor 104, but capable of capturing an image and storing it on a memory device such that the image can be downloaded or transferred to the processor 104 using, for example, a portable memory device and the like. In one aspect, the secure system 110 that a person is attempting to access can be a secure computer system such as, for example, a control system and the processor 104 can comprise a portion of the secure computer system. In other aspects, the processor 104 can be separate from, but in communication with the secure system.

Further comprising the exemplary system of FIG. 1 is an identification badge 106. The image capture mechanism 102 can capture an optical image that includes at least a portion of an identification badge 106. The identification badge 106 can comprise characteristics of the person to whom the identification badge 106 is assigned and other identifying information. For example, the identification badge 106 can include, in the form of images, text or machine-readable code (e.g., a barcode, Q/R code, etc.), a person's name, identification number, social security number, address, age, department, division, name of the person's employer or business, address or location of the person's employer or business; the person's security clearance, facial characteristics of the person, hair color of the person, eye color of the person, an image with identifiable clothing color, and the like. The identification badge may be of a color that has assigned meaning, it may include a date that the badge 106 was assigned to a person or an expiration date of the badge 106; the badge 106 may have a specific arrangement of images and text; the badge 106 may include a security image or any other identifying text, images, markings or features associated with the person or the person's identification badge 106, and the like.

Further in communication with the processor 104 is a memory 108. In one aspect, the memory 108 further comprises a database. The database can store information about users that are authorized to access the secure system. For example, the database can store information about the characteristics of users that are authorized to access the secure system such as name, identification number, social security number, address, age, size of the user's identification badge, the user's department, name of the user's employer or business, address or location of the user's employer or business; the user's security clearance, color of the user's identification badge, date on the user's identification badge, facial characteristics of the user, hair color of the user, eye color of the user, clothing color on the user's identification badge; Q/R code information from the user's identification badge; bar code information from the user's identification badge; arrangement of images and text on the user's identification badge; a security image on the user's identification badge, or any other identifying text, images, markings or features associated with the user or the user's identification badge, and the like. The memory 108 can further comprise computer-executable instructions that are stored in the memory 108 and are executable by the processor. For example, the memory 108 can be used to store one or more recognition algorithms encoded as computer-executable instructions stored in the memory 108. For example, the one or more recognition algorithms executed by the processor can include one or more of principal component analysis algorithms, Fisherface recognition algorithms, eigenfaces recognition algorithms, linear discriminate analysis algorithms, combinations and modifications thereof, and the like.

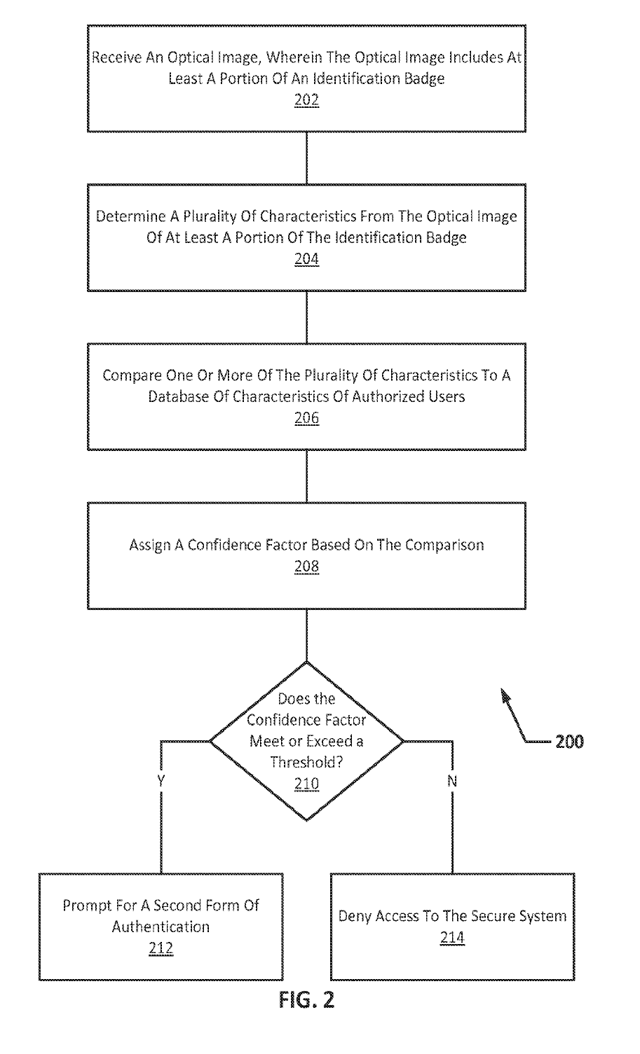

Referring now to FIG. 2, example methods of accessing a secure system requiring multi-point authentication are described. It should be understood that at least some of the steps for accessing a secure system requiring multi-point authentication can be at least partially performed by at least one processor (described above and below). Additionally, at least some of the steps for accessing a secure system requiring multi-point authentication can optionally be implemented within a cloud computing environment, for example, in order to decrease the time needed to perform the algorithms, which can facilitate visualization of the prior analysis on real-time images. Cloud computing is well-known in the art. Cloud computing enables network access to a shared pool of configurable computing resources (e.g., networks, servers, storage, applications, and services) that can be provisioned and released with minimal interaction. It promotes high availability, on-demand self-services, broad network access, resource pooling and rapid elasticity. It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring now to FIG. 2, a flow diagram illustrating example operations 200 for performing the steps of accessing a secure system requiring multi-point authentication is shown. At step 202, a processor 104 receives an optical image of at least a portion of the identification badge 106. In response, at step 204, the processor 104 determines by executing one or more of the recognition algorithms encoded as computer-executable instructions and stored in the memory 108, a plurality of characteristics from the optical image of at least a portion of the identification badge 106. The processor 104 in communication with the database stored in the memory 108 and executing the recognition algorithms stored in the memory 108 form a threshold module. At step 206, one or more of the plurality of characteristics that are determined by the processor 104 from the at least a portion of the identification badge 106 are compared, by the processor 104, to the characteristics of authorized users that are stored in the database. At step 208, the processor 104 assigns a confidence factor based on the comparison of characteristics as determined from the identification badge 106 to the characteristics stored in the database. The more characteristics as determined from the identification badge 106 that are the same or similar to the characteristics stored in the database of a particular authorized user (a positive comparison), the higher the confidence factor. At step 210, if the confidence factor meets or exceeds a threshold, then at step 212, the person attempting to access the secure system is prompted for a second form of authentication (e.g., a password, biometric information, a code, an electronic key, etc.). For example, the person attempting to access the secure system can be prompted for a second form of identification using input-output devices in communication with the processor 104. For example, the prompt can be shown on a display and a password can be entered using a keyboard, though other input-output devices are contemplated within the scope of the invention.

If the confidence factor fails to meet or exceed the threshold, then at step 214 the person attempting to access the secure system is denied access. In various aspects, the threshold can be a pre-established value that is stored in the memory 108 or, it can be a dynamically-adjusted value based on positive comparisons of certain of the plurality of characteristics. For example, if certain high-confidence characteristics are positively identified from the identification badge 106, the threshold value can be lowered, thus requiring fewer positive comparisons to meet or exceed the threshold. Alternatively, the threshold value could be static, but the characteristics from the identification badge 106 have varying (weighted) confidence values. For example, the machine-readable code on the identification badge 106 may have a higher confidence value than the color of the identification badge 106. Such comparisons, adjustment of the threshold, or weighting of the characteristics can be performed by a threshold module. The threshold module comprises computer-readable instructions stored in the memory 108 that are executed by the processor 104. The computer-readable instructions cause the processor to dynamically adjust the threshold based on positive comparisons of certain of the plurality of characteristics or, in another embodiment, the threshold module comprises computer-readable instructions stored in the memory 108 that are executed by the processor 104 that cause the processor 104 to assign weights to each of the plurality of characteristics, wherein all of the assigned weights are not equal, so that fewer or greater positive comparisons of certain characteristics are required to meet or exceed the threshold.

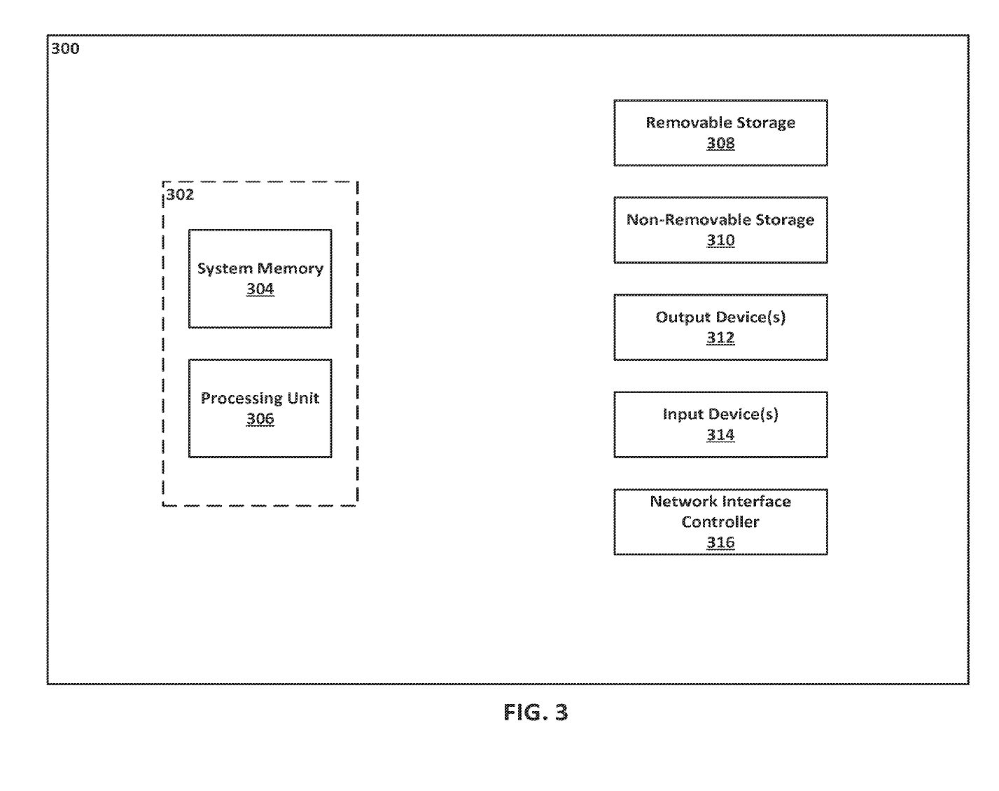

When the logical operations described herein are implemented in software, the process may execute on any type of computing architecture or platform. As noted herein, the computing device may comprise the secure system that a person is attempting to access. For example, referring to FIG. 3, an example computing device upon which embodiments of the invention may be implemented is illustrated. In particular, at least one processing device described above may be a computing device, such as computing device 300 shown in FIG. 3. The computing device 300 may include a bus or other communication mechanism for communicating information among various components of the computing device 300. In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Computer-readable media refers to any media that is capable of providing data that causes the computing device 300 (i.e., a machine) to operate in a particular fashion. Various computer-readable media may be utilized to provide instructions to the processing unit 306 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 606.

Computing device 300 typically includes a variety of non-transitory computer-readable media. Computer-readable media can be any available media that can be accessed by device 300 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 304, removable storage 308, and non-removable storage 310 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 300. Any such computer storage media may be part of computing device 300.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of accessing a secure system requiring multi-point authentication, comprising:
receiving an optical image, wherein the optical image includes at least a portion of an identification badge;
determining, by a processor executing one or more recognition algorithms encoded as computer-executable instructions, a plurality of characteristics from the optical image of at least a portion of the identification badge;
comparing, by the processor executing computer-readable instructions, one or more of the plurality of characteristics to a database of characteristics of authorized users;
assigning, by the processor executing computer-readable instructions, a confidence factor based on the comparison; and
prompting, by the processor executing computer-readable instructions, for a second form of authentication if the confidence factor meets or exceeds a threshold or denying access to the secure system if the confidence factor does not meet or exceed the threshold.

2. The method of claim 1, wherein the secure system comprises a secure computer system and the processor executing computer-readable instructions comprises a portion of the secure computer system.

3. The method of claim 2, wherein the secure computer system comprises a secure control system.

4. The method of claim 1, wherein receiving the optical image comprises receiving the optical image from an image capture mechanism, said image capture mechanism comprising at least one of a camera, a video recorder, a scanner, a display or scanner equipped with sensor technology and an optical scanner that is integrated into a touchscreen display, said image capture mechanism in communication with the processor.

5. The method of claim 1, wherein determining, by the processor executing one or more recognition algorithms encoded as computer-executable instructions, the plurality of characteristics from the optical image of at least a portion of the identification badge comprises determining at least two of name, identification number, social security number, address, age, size of the identification badge, department, name of employer or business, address or location of employer or business; security clearance, color of the identification badge, date on the identification badge, facial characteristics from an image on the identification badge, hair color from the image on the identification badge, eye color from the image on the identification badge, clothing color from the image on the identification badge; Q/R code information from the optical image of at least a portion of the identification badge; bar code information from the optical image of at least a portion of the identification badge; arrangement of images and text on the at least a portion of the identification badge; presence or absence of a security image on the at least a portion of the identification badge, or any other identifying text, images, markings or features located on the identification badge and captured in the optical image of at least a portion of the identification badge.

6. The method of claim 1, wherein the one or more recognition algorithms executed by the processor include one or more of principal component analysis algorithms, Fisherface recognition algorithms, eigenfaces recognition algorithms, linear discriminate analysis algorithms, or combinations and modifications thereof.

7. The method of claim 1, wherein prompting, by the processor executing computer-readable instructions, for a second form of authentication if the confidence factor meets or exceeds a threshold comprises prompting, on an output device in communication with the processor, for a password.

8. The method of claim 1, further comprising dynamically adjusting the threshold based on positive comparisons of certain of the plurality of characteristics.

9. The method of claim 1, further comprising assigning weights to each of the plurality of characteristics, wherein all of the assigned weights are not equal, so that fewer or greater positive comparisons of certain characteristics are required to meet or exceed the threshold.

10. A system for accessing a secure system requiring multi-point authentication, said system comprised of:
an image capture mechanism, wherein the image capture mechanism captures an optical image that includes at least a portion of an identification badge;
a memory; and
a processor in communication with the memory, wherein the processor determines by executing one or more recognition algorithms encoded as computer-executable instructions stored in the memory, a plurality of characteristics from the optical image of at least a portion of the identification badge; compares one or more of the plurality of characteristics to characteristics of authorized users, said database stored on the memory; assigns a confidence factor based on the comparison; and prompts for a second form of authentication if the confidence factor meets or exceeds a threshold or denies access to the secure system if the confidence factor does not meet or exceed the threshold.

11. The system of claim 10, wherein the secure system comprises a secure computer system and the processor executing computer-readable instructions comprises a portion of the secure computer system.

12. The system of claim 11, wherein the secure computer system comprises a secure control system.

13. The system of claim 10, wherein image capture mechanism comprises at least one of a camera, a video recorder, a scanner, a display or scanner equipped with sensor technology and an optical scanner that is integrated into a touchscreen display.

14. The system of claim 10, wherein the plurality of characteristics determined from the optical image of at least a portion of the identification badge by the processor executing one or more recognition algorithms encoded as computer-executable instructions comprises at least two of name, identification number, social security number, address, age, size of the identification badge, department, name of employer or business, address or location of employer or business; security clearance, color of the identification badge, date on the identification badge, facial characteristics from an image on the identification badge, hair color from the image on the identification badge, eye color from the image on the identification badge, clothing color from the image on the identification badge; Q/R code information from the optical image of at least a portion of the identification badge; bar code information from the optical image of at least a portion of the identification badge; arrangement of images and text on the at least a portion of the identification badge; presence or absence of a security image on the at least a portion of the identification badge, or any other identifying text, images, markings or features located on the identification badge and captured in the optical image of at least a portion of the identification badge.

15. The system of claim 10, wherein the one or more recognition algorithms executed by the processor include one or more of principal component analysis algorithms, Fisherface recognition algorithms, eigenfaces recognition algorithms, linear discriminate analysis algorithms, or combinations and modifications thereof.

16. The system of claim 10, wherein the second form of authentication comprises a password.

17. The system of claim 10, further comprising a threshold module, wherein the threshold module comprises computer-readable instructions stored in the memory that are executed by the processor, said computer-readable instructions cause the processor to dynamically adjust the threshold based on positive comparisons of certain of the plurality of characteristics.

18. The system of claim 10, further comprising a threshold module, wherein the threshold module comprises computer-readable instructions stored in the memory that are executed by the processor, said computer-readable instructions cause the processor to assign weights to each of the plurality of characteristics, wherein all of the assigned weights are not equal, so that fewer or greater positive comparisons of certain characteristics are required to meet or exceed the threshold.

19. A non-transitory computer-readable medium having computer-readable instructions for accessing a secure system requiring multi-point authentication stored thereon, which when executed by a processor, cause the processor to:
receive an optical image, wherein the optical image includes at least a portion of an identification badge;
determine a plurality of characteristics from the optical image of at least a portion of the identification badge;
compare one or more of the plurality of characteristics to a database of characteristics of authorized users;
assign a confidence factor based on the comparison; and
prompt for a second form of authentication if the confidence factor meets or exceeds a threshold or denying access to the secure system if the confidence factor does not meet or exceed the threshold.

20. The non-transitory computer-readable medium of claim 19, wherein determining a plurality of characteristics from the optical image of at least a portion of the identification badge comprises the processor executing one or more recognition algorithms encoded as computer-executable instructions, said algorithms executed by the processor including one or more of principal component analysis algorithms, Fisherface recognition algorithms, eigenfaces recognition algorithms, linear discriminate analysis algorithms, or combinations and modifications thereof.
